(19) United States
(12) Patent Application Publication
(10) Pub. No.: US 2025/0102747 A1
(43) Pub. Date: Mar. 27, 2025

(54) HOUSING STRUCTURE OF OPTICAL MODULE AND OPTICAL MODULECONTAINING THE HOUSING STRUCTURE

(71) Applicant: Source Photonics (Chengdu) Co.,Ltd., Chengdu (CN)

(72) Inventors: Libing ZHU, Chengdu (CN); Yi GAO, Chengdu (CN); Hongqi WU, Chengdu (CN)

(21) Appl. No.: 18/966,171

(22) Filed: Dec. 3, 2024

Related U.S. Application Data
(63) Continuation of application No. PCT/CN2023/122221, filed on Sep. 27, 2023.

(51) Int. Cl. G02B 6/42

(52) U.S. Cl. CPC G02B 6/4272; G02B 6/4262; G02B 6/4269; G02B 6/4277; G02B 6/428

(57) ABSTRACT

A housing structure for an optical module includes a housing and a heat dissipation component. The heat dissipation component includes a heat dissipation bottom plate and heat dissipation fins thereon. The housing structure has two opposing air guide ports, and the heat dissipation component is inside the housing. The heat dissipation fins are between the two air guide ports, and adjacent heat dissipation fins form a heat dissipation channel. Guide channels are between the heat dissipation channel and the air guide ports, and connect the heat dissipation channel to the air guide ports. This housing structure facilitates heat dissipation and inhibits solder paste to overflow through the air guide, thus avoiding contamination of the housing. The solder paste remains inside the housing, and does not affect the measurement accuracy or real-time monitoring function of temperature sensors on the housing.

### CROSS REFERENCE TO RELATED APPLICATION(S)

This application is a continuation of International Appl. No. PCT/CN2023/122221, filed Sep. 27, 2023, incorporated herein by reference.

### FIELD OF THE INVENTION

This invention relates to the field of communication, specifically to a housing structure for an optical module, and an optical module including the housing.

### DISCUSSION OF THE BACKGROUND

Optical modules are important components in optical communication technology, which can realize the mutual conversion between optical and electrical signals. Functionally, optical modules typically include optical ports, optical devices, printed circuit board assemblies (PCBAs), a base (one housing component), and a top cover (another housing component). The optical ports are usually constructed on the base and mainly used to connect to fiber jumpers. The optical devices are usually installed on the base and correspond to the optical ports. The top cover is usually installed on the base and seals the optical device and PCBA in the cavity between the top cover and the base.

In order to improve thermal conductivity and reduce EMI, more and more customers hope to use the closed top packaging form, as shown in FIG. 1. In traditional technology, there are mainly two ways to implement the closed top packaging form. The first way is to separately form the heat dissipation fin component by welding, with a plurality of fins in the heat dissipation fin component, and then bond or solder the heat dissipation fin component as a whole to the outside of the optical module housing, as shown in FIG. 1. The second method is to use aluminum extrusion molding to separately form the heat dissipation fin component, and then bond or solder the heat dissipation fin component as a whole to the outside of the optical module housing. Both implementation methods require the heat dissipation fin component to be bonded to the housing. However, the thermal conductivity of existing adhesive materials (such as commonly used Sn42Bi58 solder or adhesive, with a thermal conductivity of less than 30 W/m·k) is lower than that of the heat dissipation fin component and housing materials (usually a zinc alloy), resulting in increased thermal resistance and relatively poor heat dissipation. Additionally, the solder or adhesive may have uneven coating problems due to processing issues, affecting heat dissipation and causing adhesion problems (e.g., detachment).

To solve these technical problems, the prior art discloses a high-speed pluggable connector assembly with heat dissipation (Chinese patent CN 219226717 U). The connector assembly includes an upper housing, a lower housing, and a heat dissipation component. The upper housing and the lower housing are connected by buckles, forming an internal heat dissipation chamber. The heat dissipation component includes a heat dissipation bottom plate and fins on the heat dissipation bottom plate. The upper housing is constructed with two opposing openings, and the heat dissipation component is arranged in the heat dissipation chamber, with the top of the fins corresponding to the inner surface of the upper housing. The ends of the fins are located exactly at the openings (see FIG. 3 of the patent for details), so that the heat dissipation channel between adjacent fins can be exposed to the outside at the openings. In practical assembly, a filling material with thermal conductivity is usually required between the top of the fins and the inner surface of the upper housing. The commonly used filling material is solder paste, which not only plays a role in thermal conductivity but also in adhesion. In addition, in actual use, temperature sensors are usually installed on the outer surface of the housing of the optical module to monitor the temperature of the optical module in real time. However, in actual operation, due to certain reasons, the solder paste between the fins and the upper housing often overflows to a certain extent, and the overflowing solder paste is very easy to overflow to the outer surface of the housing, which not only causes contamination on the outer surface of the optical module housing, but also is difficult to remove, affecting the aesthetics of the optical module and the measurement accuracy of the temperature sensor, and even causing temperature monitoring failure, which urgently needs to be solved.

### SUMMARY OF THE INVENTION

One aspect of the present invention aims to solve the above-mentioned technical problems by providing a housing structure for an optical module that can effectively prevent solder paste from overflowing onto the outer surface of the housing while ensuring heat dissipation, thereby effectively solving the problems existing in the prior art.

Thus, one aspect of the invention concerns a housing structure for an optical module, comprising a housing and a heat dissipation component. The heat dissipation component comprises a heat dissipation bottom plate and a plurality of heat dissipation fins on the heat dissipation bottom plate. The housing structure has first and second air guide ports opposite each other (e.g., on opposite sides or ends of the heat dissipation component), and the heat dissipation component is inside the housing. The heat dissipation fins are between the first and second air guide ports, and a heat dissipation channel is between adjacent ones of the heat dissipation fins.

The housing structure also includes first and second guide channels respectively between the heat dissipation channel (e.g., each of two opposite sides or ends of the heat dissipation channel) and the first and second air guides, and the heat dissipation channel connects to (e.g., is in fluid communication with) the first and second air guides through the corresponding first and second guide channels. In this scheme, a guide channel is configured between the heat dissipation channel and the corresponding air guide port, so that the heat dissipation channel is connected to or in communication with the air guide port through the guide channel. On the one hand, the guide channel can play a role in guiding and diverting air, which is more conducive to guiding air flow into the heat dissipation channel, so as to remove the heat inside the heat dissipation channel and achieve better heat dissipation. On the other hand, by creating a guide channel between the heat dissipation channel and the corresponding air guide, the heat dissipation fin may be spaced away from the air guide and/or separated by the guide channel. In actual use, even if some solder paste overflows between the heat dissipation fin and the housing, the overflowing solder paste may remain inside the housing, making it difficult for the solder paste to flow outside the housing through the air guide, thus avoiding contamination on the outside of the housing. There is no need to clean or remove the solder paste from the outer surface of the optical module housing, and it will not affect the measurement accuracy and real-time monitoring of any temperature sensor, which makes it more convenient to use. In addition, due to the spacing and/or separating effect of the guide channels, it is difficult to see any overflowing solder paste from the outside, so that the overflowing solder paste will not affect the aesthetics of the housing and optical module.

Furthermore, each of the guide channels may include a plurality of guide vanes, which are in the housing and divide the guide channel into at least two sub channels. The guide vanes in the guide channels can not only guide and divert air flow, allowing it to enter each heat dissipation channel more evenly, but also further increase the heat dissipation area, thereby improving the heat dissipation effect.

To solve the problem of improving heat dissipation efficiency, further, each guide vane in each guide channel may correspond to a unique one of the heat dissipation fins (e.g., there may be an equal number of guide vanes in the first guide channel, guide vanes in the second guide channel, and heat dissipation fins), and opposite ends of the heat dissipation fin may contact the corresponding guide vanes in the first and second guide channels, respectively. Not only can each heat dissipation channel be connected to each sub channel separately, making the air volume of and/or air flow in each heat dissipation channel more uniform, but it is also more conducive to air flow entering the heat dissipation channel through one side of the sub channel and being discharged through the other side of the sub channel, which is conducive to achieving better heat dissipation. Moreover, it is conducive to achieving heat conduction between the guide vanes and the heat dissipation fins, so that the guide vanes can not only play a role in guiding the air flow, but also in heat dissipation.

Furthermore, each guide vane may have a first inclined surface facing the inside of the housing, and each heat dissipation fin may have second inclined surfaces (e.g., at each of the opposite ends) that mate with or are complementary to the first inclined surface. When the heat dissipation component is assembled to the housing, the second inclined surface contacts the corresponding first inclined surface. In this scheme, by constructing the inner surface of the guide vane as a first inclined surface facing the inner side of the housing, and constructing the outer end surfaces of the heat dissipation fin as second inclined surfaces complementary to the first inclined surface, on the one hand, during assembly, the first inclined surface can serve as a positioning and guiding function for the heat dissipation component, so that the heat dissipation component can be quickly and conveniently assembled or affixed to the housing. On the other hand, the heat dissipation fins contact the first inclined surfaces of the guide vane through the second inclined surfaces. The structure of the inclined surfaces makes the contact area larger, which is more conducive to heat transfer and thus more conducive to heat dissipation.

The second aspect of the present invention aims to solve the problem of further improving the heat dissipation effect of the optical module. For example, each of the air guide ports may have an inclined opening. In this scheme, by constructing the air guide ports with a sloped opening, on the one hand, the opening size of the air guide ports can be effectively increased without increasing the cross-sectional area of the air guide channels, which is conducive to guiding more air into and/or out of the air guide channels to remove more heat. On the other hand, at least one of the air guide ports can be effectively oriented to face outside the housing, which is conducive to guiding external air flow into and/or through the air guide channels, thereby further improving the heat dissipation by the optical module.

Furthermore, the outer end and/or surface of the guide vanes may be configured as a third inclined surface, similar to the air guide ports. It achieves better air guidance and better heat dissipation through the coordination of the third inclined surfaces and the inclined air guide port opening.

In order to improve the heat dissipation effect, further, the thickness of the heat dissipation fins may gradually decrease along the direction away from the heat dissipation bottom plate. Not only can the surface area of the heat dissipation fins be increased relative to fins with completely vertical side surfaces, which is conducive to improving heat dissipation, but the cross-sectional area of the heat dissipation channel can be increased relative to fins with completely vertical side surfaces and a thickness equal to that at the interface between the fin and the heat dissipation bottom plate, effectively increasing the flow rate of the heat dissipation channels and achieving better heat dissipation.

To solve the problem of facilitating the formation of air ducts, it is preferred that the housing comprises two side walls (which may be parallel or substantially parallel to each other), a heat dissipation wall connected between the two side walls, and first and second top walls at opposite ends of the heat dissipation wall. Opposite sides or edges of the first and second top walls are respectively connected to the two side walls. At the opposite ends of the heat dissipation wall, the heat dissipation wall, parts of the first and second top walls, and parts of the two side walls jointly enclose the air guide channels and/or define the air guide ports.

The guide vanes may be connected at least to the heat dissipation wall.

The top of each heat dissipation fin contacts the heat dissipation wall. Not only is it convenient to form air ducts (i.e., the heat dissipation channel[s]), but the air ducts also guide air more easily, which is conducive to better heat dissipation.

In some schemes, the tops of the heat dissipation fins contact the inner surface of the heat dissipation wall. This allows the heat in the heat dissipation fins to be transferred through the inner surface of the heat dissipation wall to the outer surface of the heat dissipation wall, thereby achieving a larger heat dissipation area and being more conducive to heat dissipation.

In some schemes, a filling material (e.g., a solder) with thermal conductivity (e.g., a thermal conductivity≥30 W/m·k) is between the top of the heat dissipation fins and the inner surface of the heat dissipation wall. It can effectively eliminate the gap between the heat dissipation fins and the heat dissipation wall and ensure that the heat in the heat dissipation fins can be efficiently transferred to the heat dissipation wall through the filling material, thereby improving heat dissipation.

Preferably, the guide vanes are connected between the heat dissipation wall and the top wall.

In order to solve the problem of facilitating the formation of the air guide channels, in some solutions, the air guide channels are in the housing.

The third aspect of the present invention aims to solve the problem of further improving heat dissipation by the optical module. In some solutions, the top wall and the heat dissipation wall are staggered, and the outer end or edge of each guide vane may be connected to the inner end or edge of the corresponding (e.g., nearest) top wall. The upper end of each guide vane is connected to the inner surface of the heat dissipation wall, and the lowermost end or edge of each guide vane is flush (e.g., with the lowermost ends or edges of the other guide vane, at least in that air guide channel). After the heat dissipation component is assembled on or in the housing, the lower end of each guide vane may contact the heat dissipation bottom plate of the heat dissipation component, and the heat dissipation wall, the heat dissipation bottom plate, and the two side walls jointly enclose the heat dissipation channel(s). In this scheme, the heat dissipation component and the housing are combined to enclose the air flow channel (including the heat dissipation channel[s]), which not only effectively reduces the difficulty of forming the air flow channel, but also facilitates the formation of the air flow channel. And through the contact between the guide vanes and the heat dissipation bottom plate, the heat in the heat dissipation bottom plate can be transferred to the guide vanes, which can act as heat dissipation fins and effectively increase heat dissipation.

The fourth aspect of the present invention aims to solve the problem of improving heat transfer efficiency. For example, the heat dissipation bottom plate may have grooves adapted to receive the guide vanes, where each groove may receive a single heat dissipation fin. After the heat dissipation component is assembled to the housing, the lowermost end or edge of each guide vane may be in a corresponding groove. By configuring the grooves, not only can the heat dissipation components be positioned and/or aligned correctly during assembly, but precise assembly can also be achieved quickly. Moreover, it can effectively increase the contact area between the heat dissipation bottom plate and the guide vanes, which is more conducive to heat transfer and dissipation.

Furthermore, the heat dissipation component may further comprise two outer walls on opposite sides of the heat dissipation base plate, which are respectively adapted to (e.g. aligned with and/or in contact with) the two side walls of the housing. After the heat dissipation component is assembled in the housing, the two outer walls may be respectively connected to the two side walls, so that the side walls and outer walls can jointly form the side walls of the housing in the optical module.

Furthermore, each of the outer walls may include a latch fixture.

In order to solve the problem of precise assembly, further, the heat dissipation bottom plate structure may have a plurality of first positioning parts (e.g., alignment slots), and the side wall and/or top wall of the housing structure has one or more second positioning parts (e.g., alignment tabs) adapted to or configured to mate with the first positioning parts. During assembly, the heat dissipation component is correctly positioned by the cooperation of the first positioning part and the second positioning part (i.e., the fit of the second positioning part in the first positioning part, or vice versa), allowing the heat dissipation component to be quickly and accurately assembled onto the housing.

Preferably, the heat dissipation fins are parallel to each other. Not only is it easy to process and shape, but it also helps to increase the air flow, optimize the heat dissipation area, and improve the heat dissipation.

For the convenience of production and assembly, further, the housing structure may have a plurality of first assembly parts, and the heat dissipation component first may include one or more fitting parts adapted or corresponding to the first assembly parts. The heat dissipation component is detachably secured or affixed to the housing with fasteners adapted to the first fitting parts.

Preferably, the first assembly part comprises a threaded hole, the first fitting part comprises a through hole (e.g., a ring affixed to or integral with the heat dissipation component) adapted to (e.g., in a location corresponding to) the threaded hole, and the fastener is a bolt or screw adapted to (e.g., configured to mate with or fit in) the threaded hole.

For the convenience of production and assembly, further, the housing and/or heat dissipation component may also include one or more second assembly parts, to connect the housing components of the optical module, so that the housing components can jointly enclose an internal cavity and accommodate one or more circuit boards and other devices.

Preferably, the second assembly parts include threaded holes or through holes, as described herein.

Furthermore, the housing further comprises an optical port section, connected to one end (e.g., a front end) of each of the two side walls and one of the top walls (e.g., a front top wall), where the optical port section includes an optical port.

Another aspect of the present invention concerns an optical module comprising the housing structure, a cover component, and a circuit board (e.g., a PCBA). The cover component is detachably mounted on the housing structure and surrounds an internal cavity. The circuit board is in the internal cavity and corresponds to (e.g., is between two outer walls extending from) the heat dissipation bottom plate. The circuit board generally has a heat source (e.g., one or more integrated circuits) thereon, and the heat generated by the heat source can be transferred to the heat dissipation fins through the heat dissipation bottom plate, and dissipated through the heat dissipation fins, thereby achieving the purpose of heat dissipation.

Compared with the prior art, the housing structure and optical module of the present invention is not only conducive to achieving better heat dissipation, but also in actual use, even if some solder paste overflows between the heat dissipation fins and the housing, the overflowing solder paste does not easily flow to the outside of the housing through the air guide and does not contaminate the outside of the housing, so there is no need to clean or remove the solder paste from the outer surface of the optical module housing. The measurement accuracy and real-time monitoring capability of the temperature sensor(s) are not affected, which makes the present housing structure more convenient to use and conducive to maintaining the aesthetics of the entire housing and optical module.

### BRIEF DESCRIPTION OF THE DRAWINGS

In order to more clearly illustrate the technical solutions of the embodiments of the present invention, the following drawings will be briefly described in relation to the embodiments, and it should be understood that the drawings show only some embodiments of the present invention and therefore should not be regarded as limiting the scope, and for those skilled in the art, other relevant drawings can also be obtained according to these drawings without creative effort.

FIG. 1 is a schematic diagram of a partial structure of an exemplary optical module.

FIG. 2 is a front view of a housing structure exemplifying embodiment 1 of the present invention.

FIG. 3 is a top view of the housing structure of FIG. 2.

FIG. 4 is a cross-sectional view taken along line A-A in FIG. 3.

FIG. 5 is a cross-sectional view taken along line B-B in FIG. 4.

FIG. 6 is a partial structural diagram of an exemplary housing component in embodiment 1 of the present invention.

FIG. 7 is a second schematic diagram of a partial structure of the exemplary housing component in embodiment 1 of the present invention.

FIG. 8 is a side view of an exemplary heat dissipation component in a housing structure embodying embodiment 1 of the present invention.

FIG. 9 is a top view of the exemplary heat dissipation component of FIG. 8.

FIG. 10 is a schematic diagram of the exemplary heat dissipation component embodying embodiment 1 of the present invention.

FIG. 11 is a partial schematic diagram of the exemplary heat dissipation component assembled on the exemplary housing structure in embodiment 1 of the present invention.

FIG. 12 is a schematic diagram of a partial structure of an exemplary housing component embodying embodiment 2 of the present invention.

FIG. 13 is a side view of the exemplary heat dissipation component in embodiment 2 of the present invention.

FIG. 14 is a top view of the housing structure exemplifying embodiment 1 of the present invention.

FIG. 15 is a cross-sectional view taken along line C-C in FIG. 14.

FIG. 16 is a schematic diagram of a partial structure of an exemplary housing component embodying embodiment 4 of the present invention.

FIG. 17 is a partial bottom view of the exemplary housing component of FIG. 16.

FIG. 18 is a schematic diagram of an exemplary guide vane structure for one air guide channel (e.g., a front air guide channel) in the exemplary housing component in embodiment 4 of the present invention.

FIG. 19 is a schematic diagram of the an exemplary guide vane structure for another air guide channel (e.g., a rear air guide channel) in the exemplary housing component in embodiment 4 of the present invention.

FIG. 20 is a perspective schematic diagram of an exemplary heat dissipation component for the exemplary housing structure in embodiment 4 of the present invention.

FIG. 21 is a longitudinal cross-sectional view of the exemplary housing structure in embodiment 4 of the present invention, consistent with the cross-section along line C-C in FIG. 14.

FIG. 22 is a transverse cross-sectional view of the exemplary housing structure in embodiment 4 of the present invention in an exemplary optical module, with the cross-sectional position consistent with the position cross-section along line B-B in FIG. 4.

### EXPLANATION OF MARKINGS IN THE FIGURES

Heat dissipation fin component 1, fin 11

Housing 2, side walls 21, heat dissipation wall 22, inner surface 221, top walls 23, air guide port 24, air guide channel 25, sub channel 251, first assembly parts 26, second assembly parts 27, optical port section 28, optical port 281

Heat dissipation component 3, heat dissipation bottom plate 31, grooves 311, heat dissipation fins 32, second inclined surfaces 321, heat dissipation channels 33, first mating parts 34, outer walls 35, latch fixture 351, end wall 36

First positioning parts 41, second positioning parts 42

Guide vanes 5, first inclined surfaces 51, third inclined surfaces 52

Cover component 6

Internal cavity 7

PCBA 8, heat source 81

Fasteners 9.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention. Furthermore, in the following description of the present invention, numerous specific details are set forth in order to provide a thorough understanding of the present invention. However, it will be readily apparent to one skilled in the art that the present invention may be practiced without these specific details.

### Embodiment 1

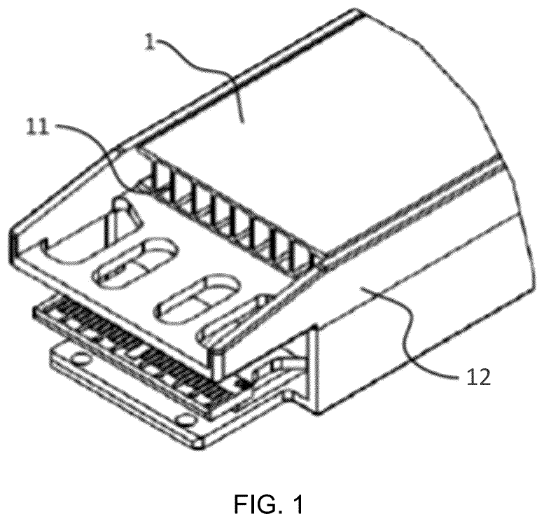

This embodiment provides a housing structure for an optical module, comprising a housing 2 and a heat dissipation component 3, as shown in FIGS. 1-5.

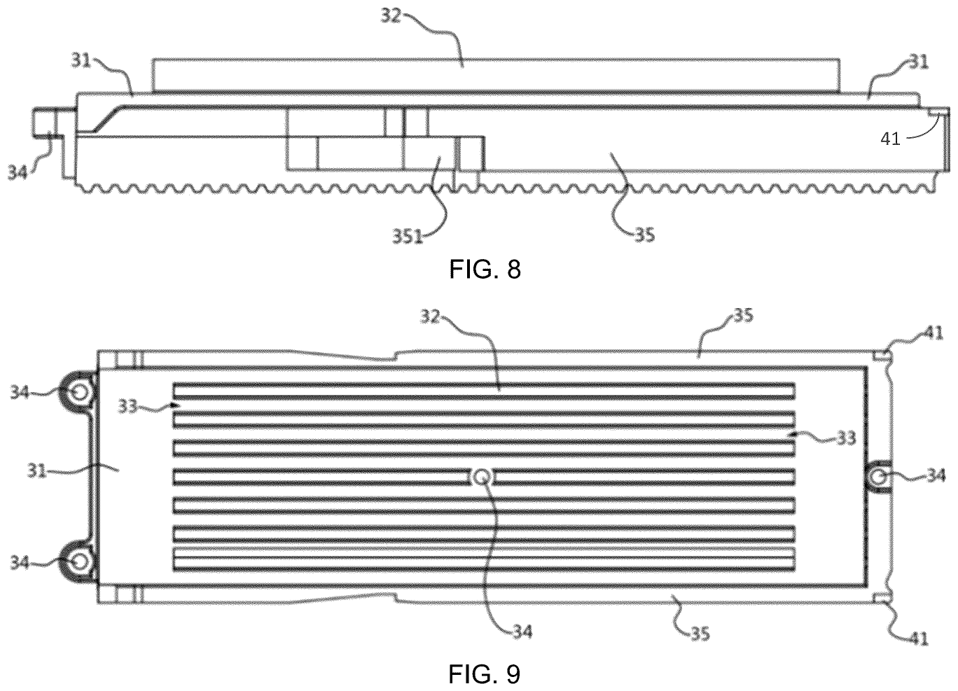

The heat dissipation component 3 includes a heat dissipation bottom plate 31 and a plurality of heat dissipation fins 32 arranged on the heat dissipation bottom plate 31, as shown in FIGS. 8 and 9. In implementation, each heat dissipation fin 32 can be parallel to the others, and each heat dissipation fin 32 is preferably perpendicular to the heat dissipation bottom plate 31, which is convenient for processing and manufacturing, and is conducive to optimizing the heat dissipation area and improving heat dissipation. The thickness, height, and spacing of the heat dissipation fins 32 can be determined according to actual heat dissipation requirements.

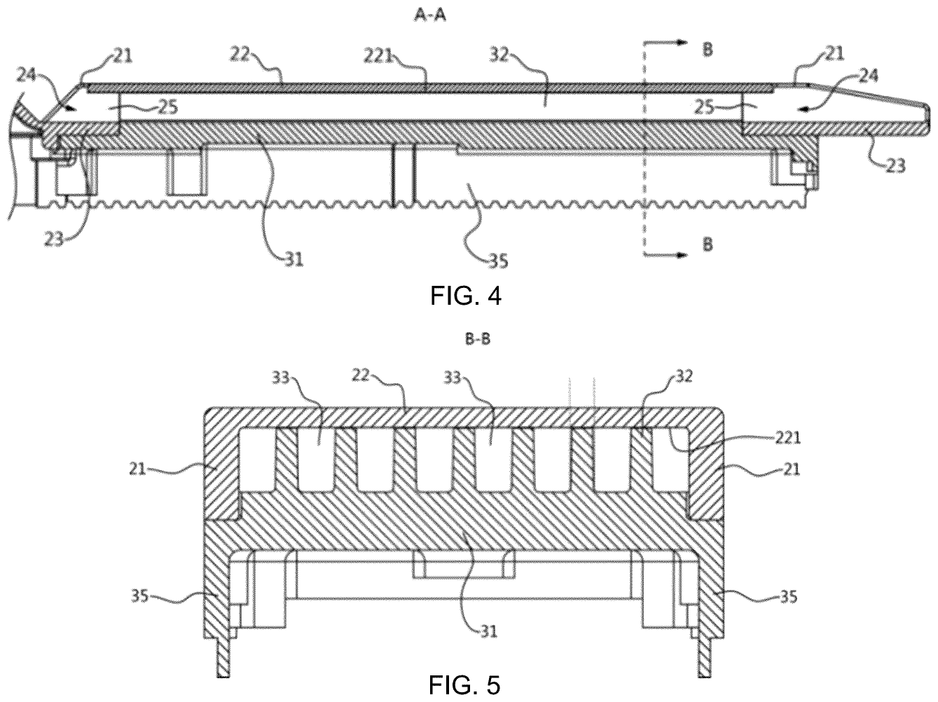

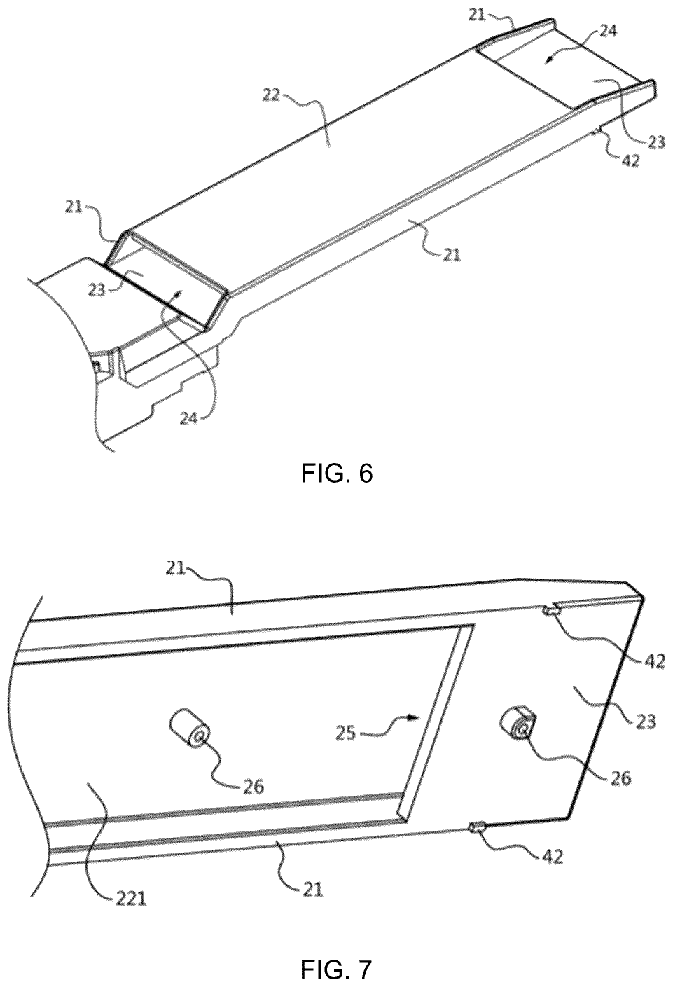

As shown in FIG. 3, FIG. 4, and FIG. 6, the housing 2 is constructed with two opposing air guide ports 24 for heat dissipation. For ease of description, in one embodiment, the housing 2 includes two opposing side walls 21, a heat dissipation wall 22 connected between the two side walls 21, and first and second top walls 23 below two opposite ends of the heat dissipation wall 22. As shown in FIGS. 3-7, the top walls 23 and the heat dissipation wall 22 are not coplanar. For example, as shown in FIG. 4, the heat dissipation wall 22 is the outermost surface on one side of the optical module, further away from the center of the optical module than the top walls 23. For ease of description, in this embodiment, the outer surface of the heat dissipation wall 22 is the outermost side or surface of the housing 2, and the inner surface 221 of the heat dissipation wall 22 faces the inside of the housing 2. The top walls 23 and the heat dissipation wall 22 can be parallel to each other, and two opposite sides or edges of each of the top walls 23 are respectively connected to the two side walls 21. As shown in FIGS. 3, 4, and 7, at opposite ends of the heat dissipation wall 22, the heat dissipation wall 22, the top walls 23, and the two side walls 21 jointly enclose the first and second air guides 24. The two top walls 23 at the ends of the heat dissipation wall 22 are spaced apart, as shown in FIGS. 3 and 4, so that a gap exists between the two top walls 23 for the installation of the heat dissipation fins 32 of the heat dissipation component 3.

In this embodiment, the heat dissipation component 3 is assembled or secured to the housing 2, as shown in FIGS. 4, 5, and 11, so that the heat dissipation fins 32 are inside the housing 2, between the two air guide ports 24, and the heat dissipation fins 32 can cooperate with (e.g., contact, directly or using a thermally conductive adhesive, such as a solder) the heat dissipation wall 22 of the housing 2, thereby forming heat dissipation channels 33 between adjacent heat dissipation fins 32, as shown in FIG. 5. When the heat dissipation component 3 includes three or more heat dissipation fins 32, a plurality of the heat dissipation channels 33 are formed. For example, the heat dissipation component 3 may comprise n heat dissipation fins 32, and the adjacent pairs of heat dissipation fins 32 form n-1 heat dissipation channels 33. When secured to the housing 2, the outermost heat dissipation fins 32 and the two side walls 21 can form two additional heat dissipation channels. In this embodiment, the ends of the heat dissipation fins 32 do not extend to the air guide ports 24. In fact, in this embodiment, there is also a guide channel 25 between the heat dissipation channels 33 and each of the air guide ports 24, and the heat dissipation channels 33 are connected to or in fluid communication with the air guide ports 24 through the respective guide channels 25.

In implementation, the side surfaces of the heat dissipation fins 32 having the largest surface area, facing the heat dissipation channels 33, may have a certain slope, so that the thickness of the heat dissipation fins 32 gradually decreases from the heat dissipation base plate 31 to the heat dissipation wall 22, as shown in FIG. 5. This increases the surface area of the heat dissipation fins 32 relative to fins having straight vertical side walls, which is more conducive to achieving better heat dissipation, and may increase the cross-sectional area of the heat dissipation channel 33 relative to fins having a uniform thickness equal to that of the heat dissipation fins 32 at the interface with the heat dissipation bottom plate 31, which may effectively increase the flow rate of air in the heat dissipation channel 33 and improve heat dissipation.

In implementation, the air guide channels 25 can be implemented in various ways. For example, the air guide channel 25 can be directly formed in the housing 2. For example, the top walls 23 of the housing 2 can extend inside the heat dissipation wall 22, so that the top walls 23, the heat dissipation wall 22, and the two side walls 21 can jointly enclose the air guide channels 25, as shown in FIGS. 3, 4, 6, and 7. During assembly, the heat dissipation fins 32 of the heat dissipation component 3 are inserted between the guide channels 25, so that the heat dissipation channels 33 are connected to and/or communicate with the corresponding air guide ports 24 through the guide channels 25. During assembly, the ends of the heat dissipation channels 33 can be directly exposed to the air guide channels 25 for better heat dissipation.

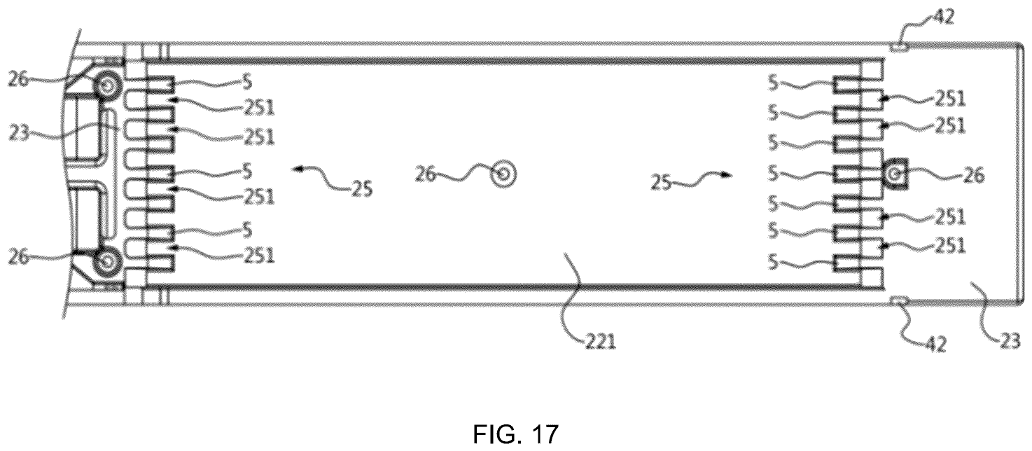

For the convenience of production and assembly, during implementation, the housing 2 includes a plurality of first assembly parts 26, as shown in FIGS. 7 and 17-19. The heat dissipation component 3 includes first fitting parts 34 that correspond to and/or align with the first assembly parts 26, so that the heat dissipation component 3 can be detachably secured to the housing 2 using fasteners 9 that pass through the first fitting parts 34 and mate with and/or securely fit in the first assembly parts 26. In implementation, the first assembly parts 26 and the first fitting parts 34 can be implemented in various ways. For example, the first assembly part 26 can include a threaded hole (e.g., in a post, adapted to receive a bolt or screw), the first fitting part 34 can be a through hole (e.g., in the heat dissipation bottom plate 31 or a tab extending therefrom) that fits (e.g., having a same diameter as) and/or aligns with the threaded hole, and each of the fasteners 9 can be a bolt or screw that fits and/or mates with the threaded hole, so that the fasteners 9 can secure the heat dissipation component 3 to the housing 2. Alternatively, each of the first assembly parts 26 can comprise a through hole, and each of the first fitting parts 34 can comprise a threaded hole with which the through holes align, and the fasteners 9 (e.g., a plurality of bolts or screws that fit and/or mate with the threaded holes) can secure the housing 2 to the heat dissipation component 3. In another alternative, the first assembly parts 26 and the first fitting parts 34 can comprise a plurality of mutually cooperating buckle structures that can also achieve detachable connection, which will not be described here. During implementation, it may be preferred that the first fitting parts 34 are on or in the heat dissipation bottom plate 31.

After assembly, the top of each heat dissipation fin 32 may contact the inner surface 221 of the heat dissipation wall 22, as shown in FIGS. 4 and 5. During implementation, the top of the heat dissipation fins 32 can press against the inner surface 221 of the heat dissipation wall 22, allowing the heat in the heat dissipation fin 32 to be transferred to the outer surface of the heat dissipation wall 22 through the inner surface 221 of the heat dissipation wall 22, thereby achieving a larger heat dissipation area (e.g., than with using the fins alone) and improving heat dissipation.

In a preferred embodiment, a filling material is provided between the top of the heat dissipation fin 32 and the inner surface 221 of the heat dissipation wall 22. The filling material has at least the function of thermal conductivity. For example, the filling material may have a thermal conductivity of 30 W/m·k or greater, although in some applications, a filling material having a lower thermal conductivity is also acceptable. Examples of filling materials (e.g., solders) having a thermal conductivity of 30 W/m·k or greater include those comprising tin (Sn) and/or lead (Pb), typically in an amount of at least 50 at. %, and one or more of copper (Cu), nickel (Ni), and silver (Ag), typically in amounts of 10 at. % or less. During implementation, a solder (e.g., a solder paste) can be used as the filling material. Solder paste not only has good thermal conductivity, but also has good adhesion properties. The filling material (e.g., solder paste) effectively eliminates the gap between the heat dissipation fin 32 and the heat dissipation wall 22, thereby adhering the heat dissipation fin 32 to the heat dissipation wall 22 and conducting heat from the heat dissipation fin 32 to the heat dissipation wall 22, ensuring that the heat in the heat dissipation fin 32 is efficiently transferred to the heat dissipation wall 22, and improving heat dissipation.

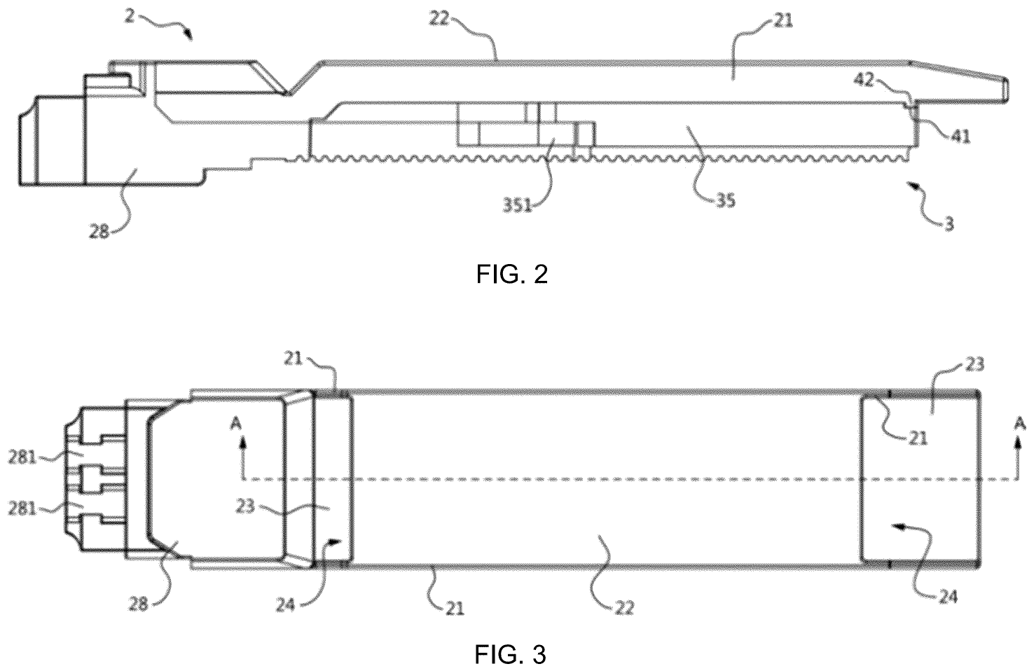

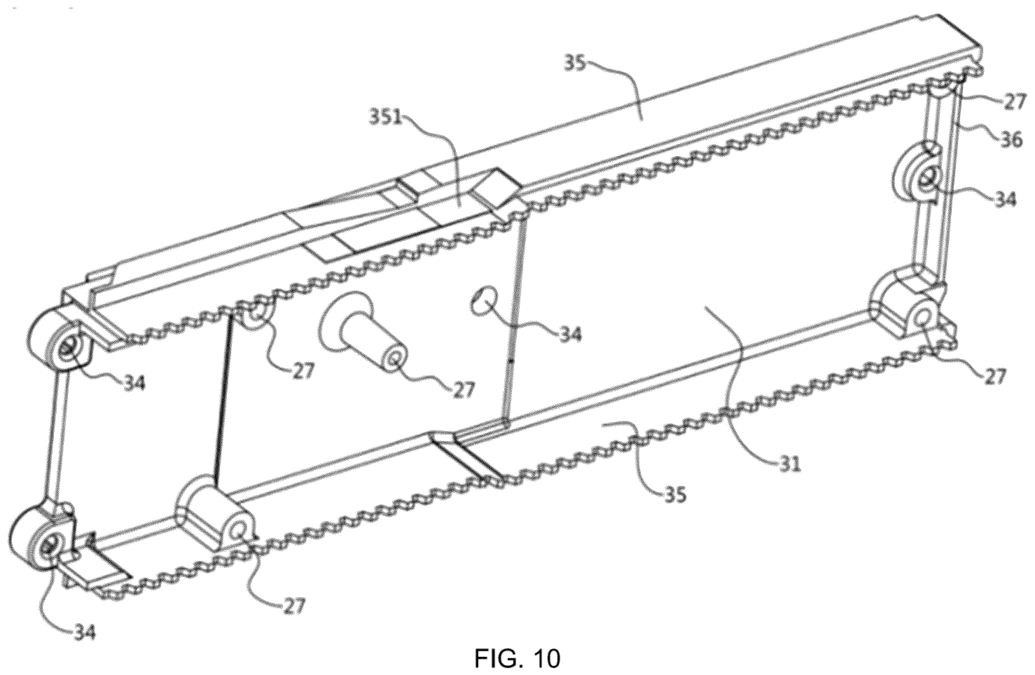

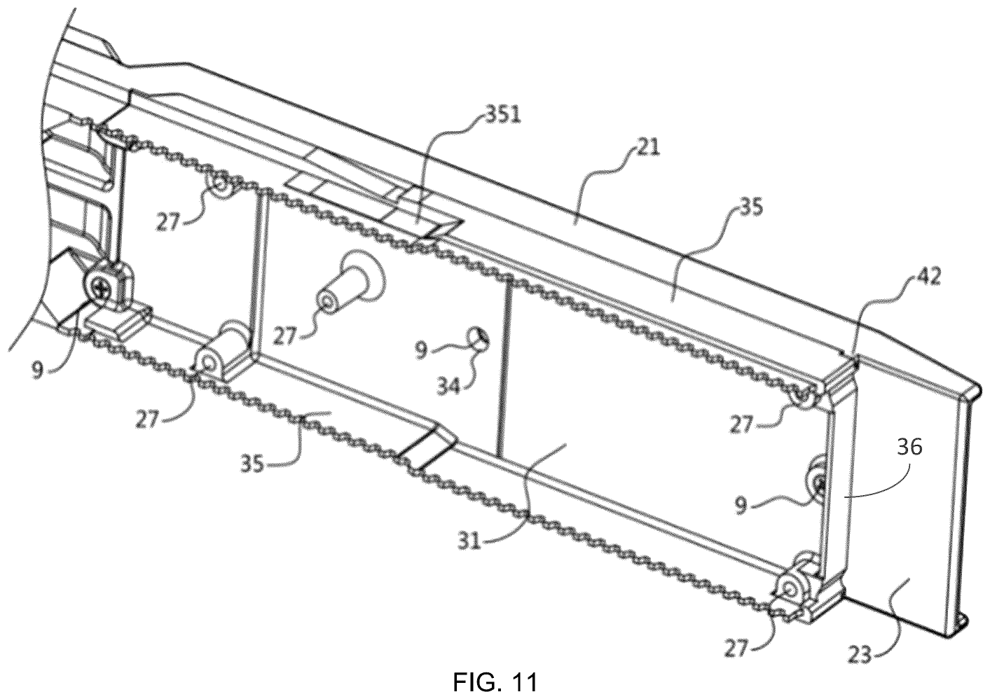

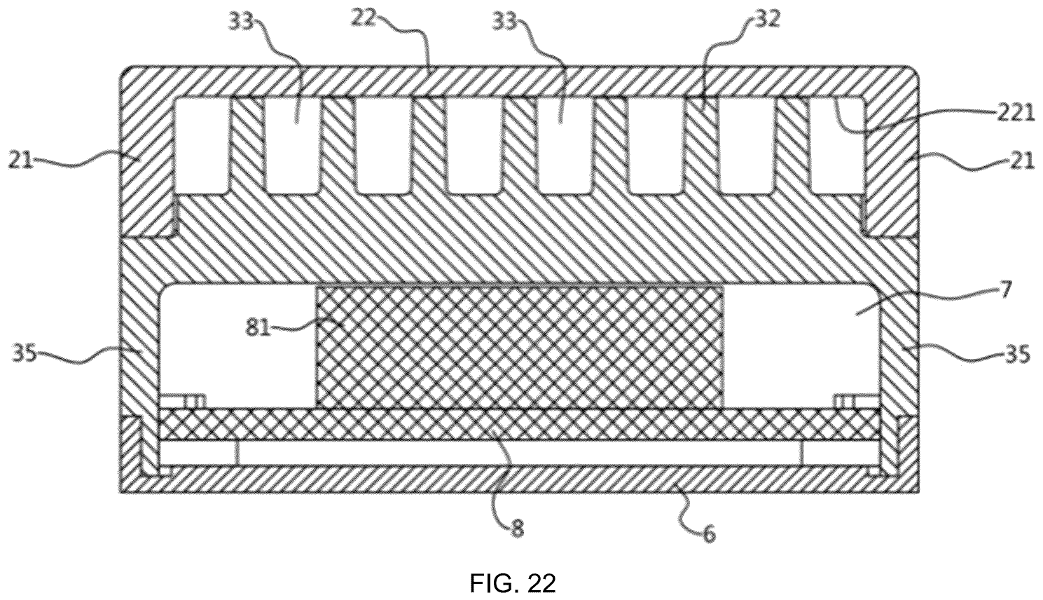

In a more complete solution, the heat dissipation component 3 also includes two outer walls 35 on opposite sides of the heat dissipation bottom plate 31, as shown in FIGS. 2, 4-5, and 8-11. The two outer walls 35 are in parallel, opposite each other, and are respectively adapted to (e.g., aligned with and/or configured to fittingly contact) the two side walls 21 in the housing 2. After the heat dissipation component 3 is assembled onto the housing 2, the two outer walls 35 are respectively connected to the two side walls 21, as shown in FIGS. 10 and 11, so that the side walls 21 and the outer walls 35 jointly form side walls of the optical module. In a more comprehensive solution, each outer wall 35 is also equipped with a latch fixture 351 configured to connect the optical module to and disconnect the optical module from a latch mechanism in a receptacle for the optical module (not shown). The latch fixture 351 can be implemented using existing technology, which will not be described here. However, the latch fixtures 351 are constructed on the heat dissipation component 3 for easier processing and assembly. In addition, when the latch mechanism and receptacle are made of or include a thermally conductive material (e.g., an aluminum alloy, stainless steel, etc.), the latch mechanism and receptacle can also help to dissipate heat from the heat dissipation component 3. In order to facilitate cooperation with the cover component 6 and enclose an internal cavity 7 (see FIG. 22), in a more complete implementation, the heat dissipation component 3 also includes an end wall 36 connected to one end (e.g., a rear end) of the two outer walls 35, as shown in FIGS. 10-11, to cooperate (e.g., align) with the cover component 6 (e.g., a corresponding end wall in the cover component 6) in the optical module. As shown in FIGS. 8 and 10, the lower edge of the outer wall 35 can have a sawtooth shape to reduce electromagnetic interference (EMI) from the optical module and/or to match or fit with the cover component 6 in the optical module.

In order to facilitate precise and rapid assembly of the heat dissipation component 3, in a further embodiment, the heat dissipation bottom plate 31 may include a plurality of first positioning parts 41, and correspondingly, the side wall 21 and/or rear top wall 23 of the housing 2 may include second positioning parts 42 adapted and/or complementary to the first positioning parts 41. During assembly, the quick positioning of the heat dissipation component 3 can be achieved by the cooperation and/or fit of the first positioning part 41 and the second positioning part 42, so that the heat dissipation component 3 can be quickly and accurately aligned with and/or assembled onto the housing 2. In implementation, the first positioning part 41 may be a positioning protrusion or alignment slot, and the second positioning part 42 may be a positioning groove or alignment tab adapted or complementary to and/or configured to mate with the positioning protrusion. Alternatively, the first positioning part 41 may comprise a positioning groove or alignment slot, as shown in FIGS. 8-10, and the second positioning part 42 may comprise a positioning protrusion or alignment tab configured to mate with, or adapted or complementary to, the positioning groove or alignment slot, as shown in FIGS. 6, 7 and 11.

In a more complete solution, the housing 2 and/or the heat dissipation component 3 may also include a plurality of second assembly parts 27 for connecting the cover component 6, as shown in FIGS. 10 and 11, so that the housing 2 and/or the heat dissipation component 3 can jointly enclose an internal cavity 7 with the cover component 6 and accommodate one or more circuit boards and other devices (e.g., one or more integrated circuits and/or discrete electrical devices on the circuit board[s]), as shown in FIG. 22. In implementation, each of the second assembly parts 27 can independently comprise a threaded hole, a through hole, or a male or female buckle in a buckle structure or mechanism. As an example, in this embodiment, the second assembly parts 27 comprise threaded holes (e.g., in a cylindrical or semi-cylindrical post) on an underside of the heat dissipation component 3, and the housing 2 and/or the heat dissipation component 3 may include a plurality of threaded holes for detachable connection of the cover component 6 using fasteners similar or identical to the fasteners 9.

In a more complete solution, the housing 2 also includes an optical port section 28, with one end (e.g., a front end) of the two side walls 21 and one top wall 23 (e.g., the front top wall) connected to the optical port section 28, as shown in FIGS. 2 and 3. The optical port section 28 includes one or more (e.g., a pair of) optical ports 281 for connecting fiber jumpers or other optical transmission medium connectors. Correspondingly, optical components in the optical module, such as a photodetector and/or a light emitting device (LED), are usually positioned near the optical port 281 inside the optical port section 28.

In implementation, the housing 2 may comprise a zinc alloy, and correspondingly, the heat dissipation component 3 can also comprise the same or different zinc alloy. However, other thermally conductive materials, such as aluminum alloys, copper and copper alloys (e.g., brass), stainless steel, etc., are also suitable for part or all of the housing 2 and/or the heat dissipation component 3.

### Embodiment 2

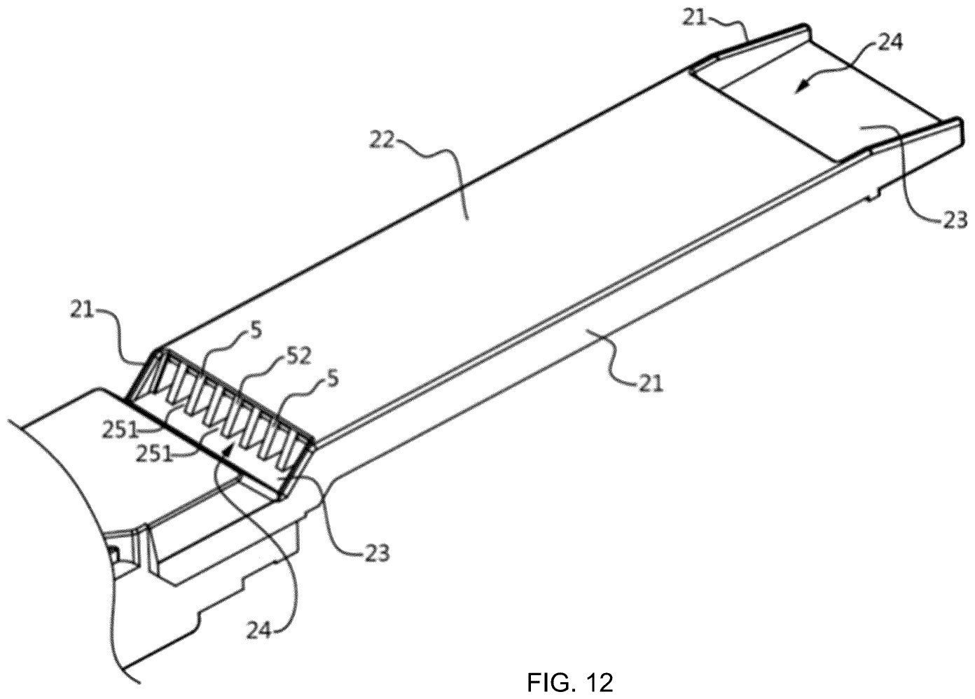

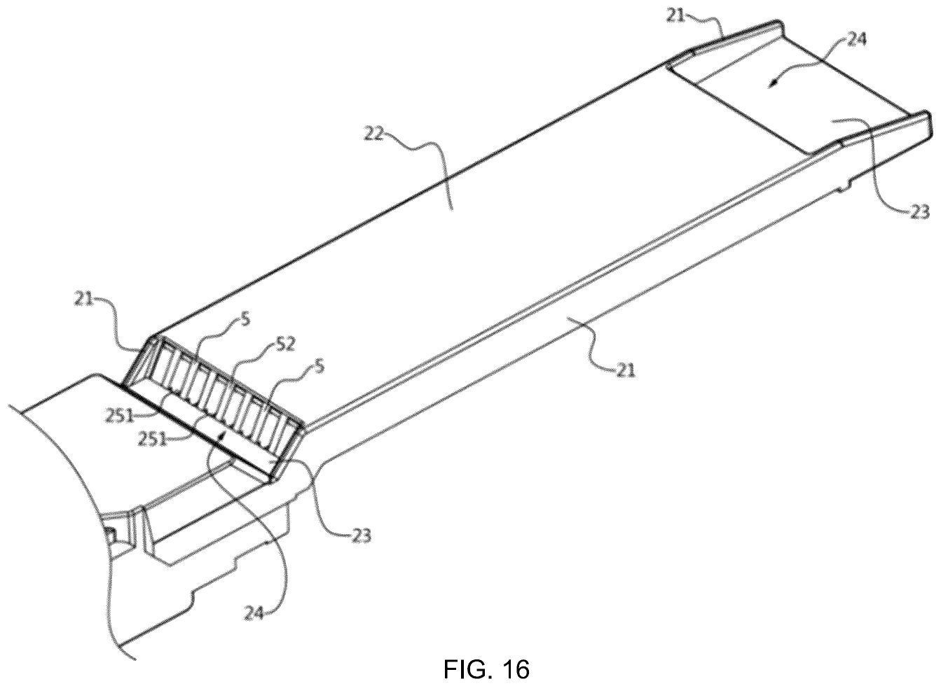

In order to solve the problem of improving heat dissipation efficiency, the main difference between this embodiment 2 and the above embodiment 1 is that in the structure of the housing 2 in this embodiment, the guide channel 25 includes a plurality of guide vanes 5 therein, whereby the guide channel is divided into at least two sub channels 251, as shown in FIGS. 12, 14 and 16. By configuring guide vanes 5 in the guide channel 25, not only can the guide vanes 5 be used to guide and divert the air flow more evenly into each heat dissipation channel 33, but also the heat dissipation area can be further increased (e.g., relative to embodiment 1), thereby improving heat dissipation.

In implementation, the guide vanes 5 are on and/or in the housing 2, as shown in FIGS. 12, 14 and 16. For example, the guide vanes 5 can be connected to the heat dissipation wall 22. In a preferred embodiment, the guide vanes 5 are connected to both the heat dissipation wall 22 and one of the top walls 23, and each guide vane 5 is preferentially orthogonal to the heat dissipation wall 22 and the one top wall 23, as shown in FIGS. 12 and 14.

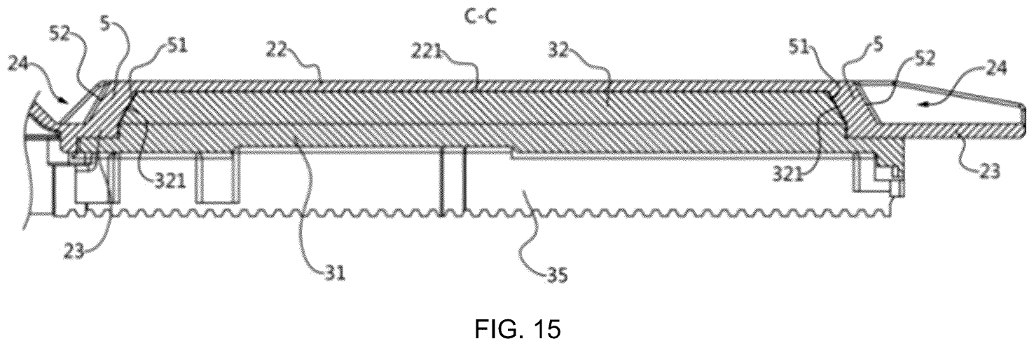

In implementation, the number of sub channels 251 can be greater than, equal to, or greater than the number of heat dissipation channels 33. In order to optimize the heat dissipation, in a preferred embodiment, each of the guide vanes 5 corresponds to a unique heat dissipation fin 32 (that is, the number of guide vanes 5 is equal to the number of heat dissipation fins 32), and the ends of each of the heat dissipation fins 32 can contact the corresponding guide vanes 5 (e.g., on opposite ends of each heat dissipation fin 32), as shown in FIG. 15. This not only allows each heat dissipation channel 33 to be connected to and/or in fluid communication with each sub channel 251, but also makes the air volume of and/or air flow in each heat dissipation channel 33 more uniform, which is more conducive to air flow entering the heat dissipation channel 33 through one side of the sub channel 251 and being discharged through the other side of the sub channel 251, and is conducive to improved heat dissipation. Moreover, it is conducive to achieving more efficient heat conduction between the guide vanes 5 and the heat dissipation fins 32, so that the guide vanes 5 can guide the air flow, and dissipate heat in a manner similar or equivalent to the heat dissipation fins 32, which assists heat dissipation.

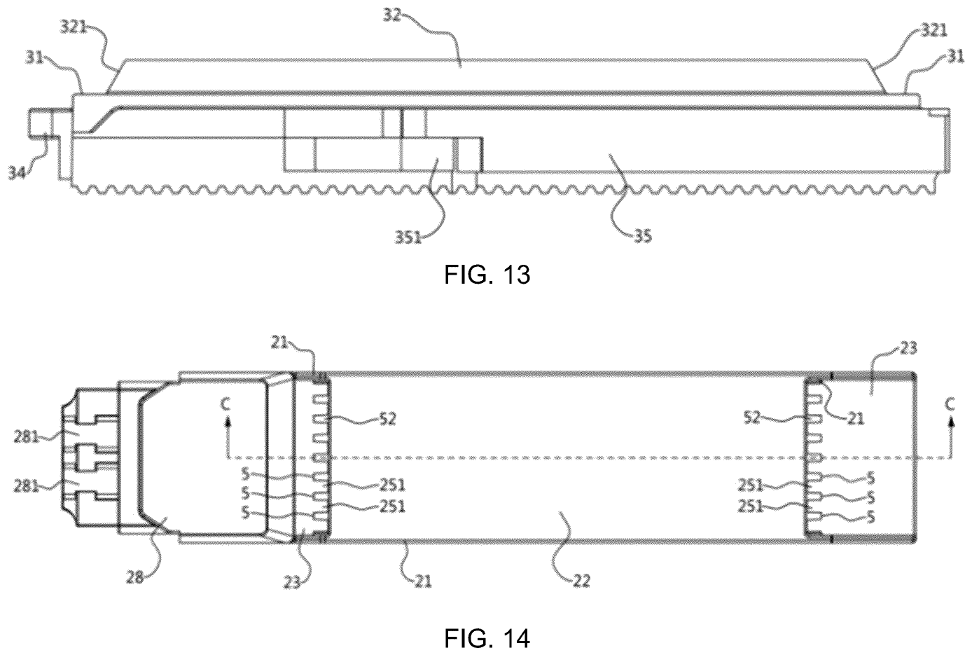

As each end of the heat dissipation fins 32 is pressed against one of the guide vanes 5, in a further embodiment, the inner surface or edge of the guide vanes 5 (i.e., the end facing the inside of the housing 2) can be sloped (e.g., a first inclined surface 51), as shown in FIG. 15. Correspondingly, the ends or surfaces of the heat dissipation fins 32 contacting the guide vanes 5 can be similarly sloped (e.g., a second inclined surface 321, adapted and/or complementary to the first inclined surface 51, as shown in FIGS. 13 and 15), so that when the heat dissipation component 3 is assembled on and/or in the housing 2, the second inclined surface 321 contacts the corresponding first inclined surface 51. Thus, the angle α of the first inclined surface 51 and the angle β of the second inclined surface 321 relative to the planes of the heat dissipation wall 22 and the top walls 23 are not 90° (e.g., one of α and β may be in a first range of 45°-75° and the other of α and β may be in a second range of 105°-135°), but preferably, α+β=180°. On the one hand, during assembly, the first inclined surface 51 can play a positioning and guiding role for the heat dissipation component 3, so that the heat dissipation component 3 can be quickly and conveniently assembled to the housing 2. On the other hand, the heat dissipation fins 32 contact the first inclined surface 51 of the guide vane 5 through the second inclined surface 321. The inclined surface makes the contact area larger and more conducive to heat transfer relative to surfaces or edges that are orthogonal (i.e., at an angle of 90° to the heat dissipation wall 22 and the corresponding top wall 23), and thus more conducive to heat dissipation. In implementation, the inclination angle of the first slope 51 can be determined according to actual needs, and the inclination angle of the second slope 321 can be adapted or complementary to the first slope 51.

### Embodiment 3

In order to further improve the heat dissipation effect, the main difference between this embodiment 3 and the above embodiments 1 and 2 is that in the structure of the housing 2 provided in this embodiment, at least one of the air guides 24 has an inclined opening, as shown in FIGS. 6, 12 and 14-16 (that is, the angle between the plane of the opening of the air guide 24 and the top wall 23 is an acute angle). By constructing the air guide 24 with an inclined opening, on the one hand, the size of the opening of the air guide 24 can be effectively increased without increasing the cross-sectional area of the air guide channel 25, which is conducive to guiding more air flow into the air guide channel 25 to remove more heat, and on the other hand, the orientation of the opening of the air guide 24 can be effectively changed. When the air guide 24 faces at least partially towards the outside of the housing 2, rather than directly towards the optical port section 28, more external air flow may enter into the air guide channel 25, thereby further improving the heat dissipation of the optical module.

In implementation, the outer end or edge of the guide vanes 5 can be perpendicular to the corresponding top wall 23. However, in a preferred embodiment, the outer end or edge of the guide vanes 5 can be sloped (e.g., have a third inclined surface 52), similar to the opening of the air guide port 24, as shown in FIGS. 12, 15 and 16. That is, the outer end or edge of the guide vanes 5 can also have an inclined surface, and the angle of inclination can be consistent with the angle of inclination of the opening of the air guide port 24 (e.g., between the angle of inclination of the opening of the air guide port 24 and 90°), as shown in FIGS. 12, 14 and 15, in order to improve the air guiding and heat dissipation effects through the cooperation between the third inclined surface 52 and the inclined opening of the air guide port(s) 24.

### Embodiment 4

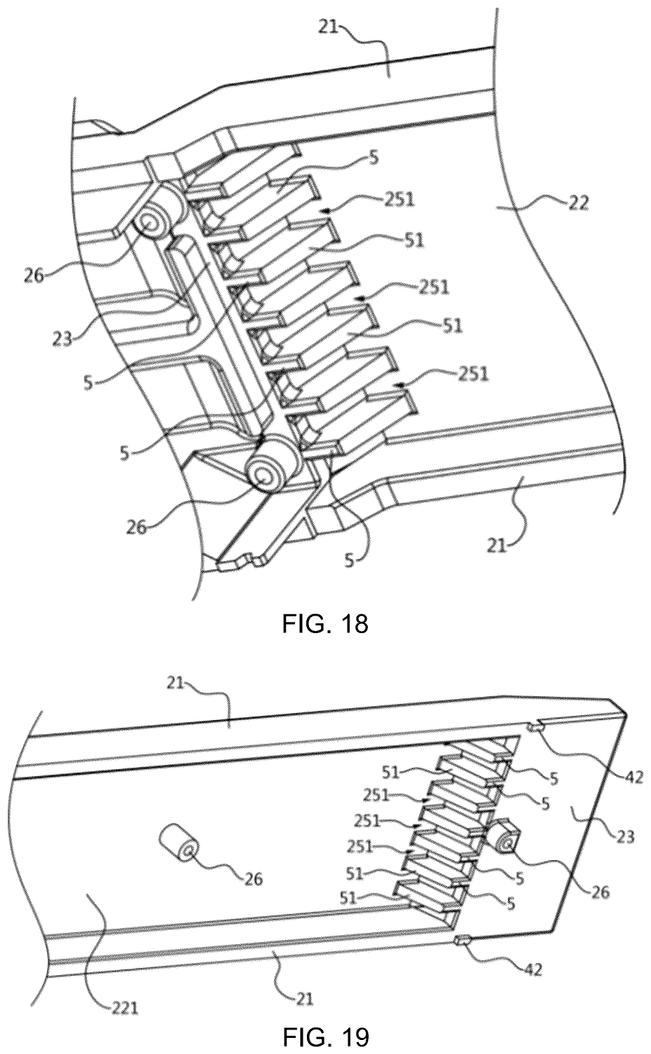

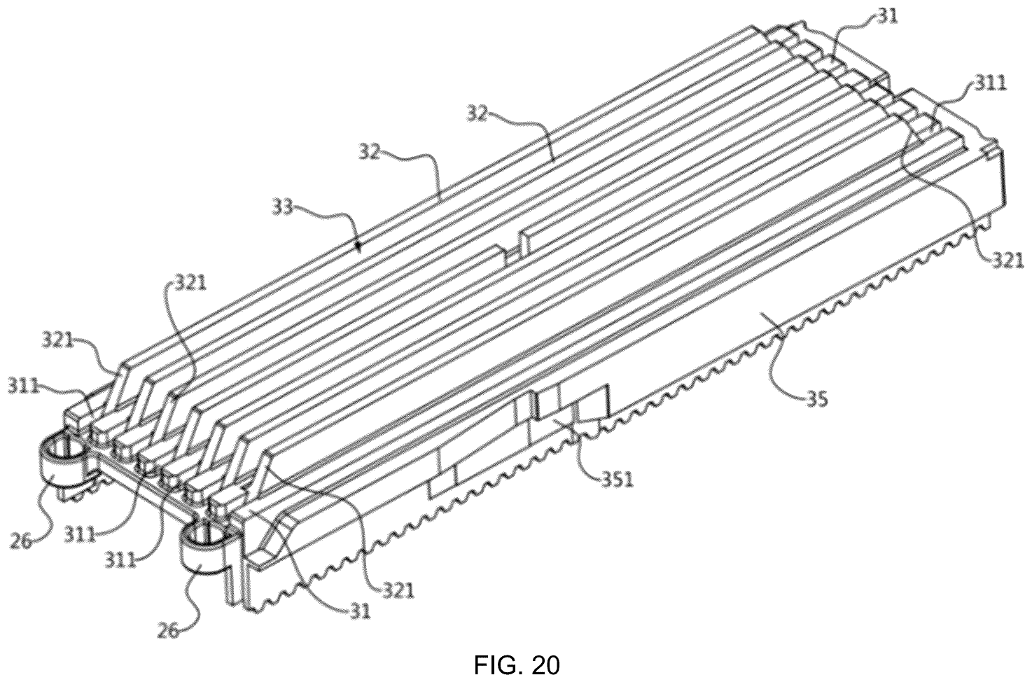

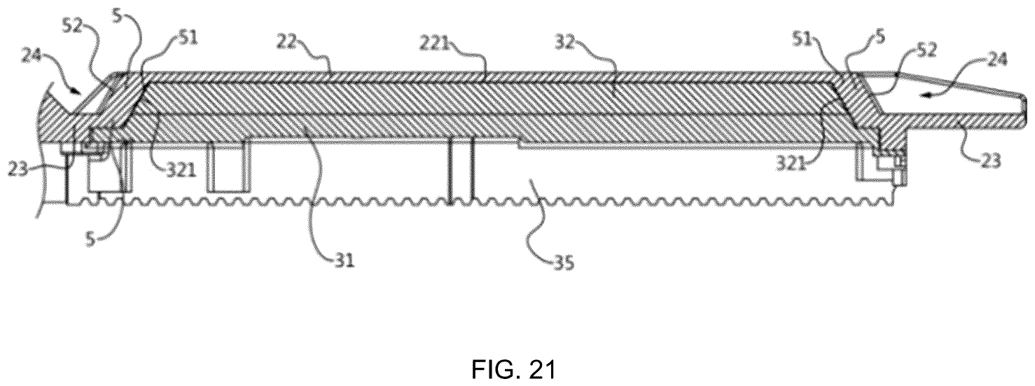

In order to facilitate the formation of the air guide channel 25 and improve heat dissipation, the main difference between this embodiment 4 and the above embodiments 1, 2 and 3 is that the air guide channel 25 has a different structure in the housing 2 in this embodiment. Specifically, in this embodiment, the top walls 23 and the heat dissipation wall 22 can be staggered (that is, in a plan view, the top walls 23 may be offset from the heat dissipation wall 22; i.e., they may not coincide or overlap). In this embodiment, the outer (and optionally lower or lowermost) ends or edges of each guide vane 5 can be connected to the end of the corresponding top wall 23, as shown in FIGS. 18 and 19. At the same time, the upper ends or edges of each guide vane 5 can be respectively connected to the inner surface 221 of the heat dissipation wall 22, and the lower ends or edges of each guide vane 5 may be flush (e.g., with each other), as shown in FIGS. 18 and 19. The heat dissipation bottom plate 31 of the heat dissipation component 3 may reserve an area for contact with the lowermost edges or ends of the guide vanes 5, and the heat dissipation fins 32 are not in this contact area, as shown in FIG. 20, so that when the heat dissipation component 3 is assembled to the housing 2, the lower ends of each guide vane 5 are in contact with the heat dissipation bottom plate 31, the heat dissipation wall 22, and one of the two top walls 23 of the heat dissipation component 3. The heat dissipation bottom plate 31, the heat dissipation wall 22, and the two side walls 21 jointly enclose the air guide channels 25, as shown in FIG. 21. In this embodiment, the heat dissipation component 3 and the housing 2 cooperate to enclose the air guide channels 25, which facilitates and/or effectively reduces the difficulty of forming the air guide channels 25. Moreover, through the direct contact between the guide vanes 5 and the heat dissipation bottom plate 31, the heat in the heat dissipation bottom plate 31 can be transferred to the guide vanes 5, so that the guide vanes 5 can function similarly or equivalently to the heat dissipation fins 32. Based on the inventive concept in this embodiment, it is equivalent to forming multiple spliced fins (heat dissipation fins 32 and guide vanes 5) between the two air guide ports 24, where each fin contacts the heat dissipation bottom plate 31, thereby effectively increasing heat dissipation.

In a further embodiment, the heat dissipation bottom plate 31 may also contain grooves 311 adapted to receive the guide vanes 5 (e.g., the lowermost edge or end of the guide vanes 5), as shown in FIG. 20. Each groove 311 may also be aligned with or configured to receive one of the heat dissipation fins 32, so that when the heat dissipation component 3 is assembled to the housing 2, the lower end of each guide vane 5 can be inserted into a groove 311. The configuration of the grooves 311 helps to position the heat dissipation component 3 during assembly, achieving precise assembly quickly, and effectively increases the contact area between the heat dissipation bottom plate 31 and the guide vanes 5, which improves heat transfer and dissipation.

### Embodiment 5

This embodiment provides an optical module, comprising the housing 2 and the heat dissipation component 3 as described in any of embodiments 1-4, and further comprising a cover component 6 and a circuit board (e.g., a PCBA) 8, which may be adapted to the housing 2 and/or heat dissipation component 3. The cover component 6 can be detachably secured to the housing 2 and/or heat dissipation component 3 through fasteners 9 or buckles, and encloses an internal cavity 7. As an example, in a preferred embodiment, the housing 2, the heat dissipation component 3, and the cover component 6 jointly enclose the internal cavity 7, as shown in FIG. 22. The circuit board 8 can be in the internal cavity 7 and have one or more heat sources (e.g., integrated circuits and/or discrete electrical components) thereon, which can transfer heat to the heat dissipation bottom plate 31, as shown in FIG. 22. The heat source 81 inside the optical module, including the heat source 81 on the circuit board 8, can correspond to or contact the heat dissipation bottom plate 31, so that the heat generated by the heat source 81 can be transferred to the heat dissipation fins 32 through the heat dissipation bottom plate 31 and dissipated through the heat dissipation fins 32, thereby achieving the purpose of heat dissipation.

Of course, during implementation, a thermally conductive material such as a thermally conductive solder can be between the heat source 81 and the heat dissipation bottom plate 31. The thermally conductive material can be a solder paste, a heat dissipating silicone, a heat dissipating mud, etc., adapted to facilitate heat transfer smoothly and efficiently to the heat dissipation bottom plate 31. Here, we will not provide examples one by one.

### CONCLUSION

The foregoing descriptions of specific embodiments of the present invention have been presented for purposes of illustration and description. They are not intended to be exhaustive or to limit the invention to the precise forms disclosed, and obviously many modifications and variations are possible in light of the above teachings. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A housing structure for an optical module, comprising a housing, a heat dissipation component, and first and second guide channels, wherein:
the heat dissipation component comprises a heat dissipation bottom plate and a plurality of heat dissipation fins on the heat dissipation bottom plate,
the housing comprises first and second air guide ports opposite to each other,
the heat dissipation component is inside the housing,
the heat dissipation fins are between the first and second air guide ports,
adjacent heat dissipation fins form a heat dissipation channel,
the first guide channel is between the heat dissipation channel and the first air guide port,
the second guide channel is between the heat dissipation channel and the second air guide port, and
the heat dissipation channel is connected to the corresponding air guide port through the guide channel.

2. The housing structure according to claim 1, further comprising a plurality of guide vanes in each of the first and second guide channels that divide each of the first and second guide channels into at least two sub channels.

3. The housing structure according to claim 2, wherein each of the plurality of guide vanes corresponds to a unique one of the plurality of heat dissipation fins, and an end of each of the plurality of heat dissipation fins contacts the corresponding one of the plurality of guide vanes.

4. The housing structure according to claim 3, wherein each of the plurality of guide vanes has a first inclined surface, and the end of each of the plurality of heat dissipation fins has a second inclined surface in contact with the first inclined surface.

5. The housing structure according to claim 2, wherein each of the first and second air guide ports has an inclined opening.

6. The housing structure according to claim 5, wherein each of the plurality of guide vanes has an outer end with a third inclined surface.

7. The housing structure according to claim 1, wherein each of the plurality of heat dissipation fins has a thickness that gradually decreases along a direction away from the heat dissipation bottom plate.

8. The housing structure according to claim 2, wherein:
the housing comprises two side walls opposite to each other, a heat dissipation wall between the two side walls, and first and second top walls at ends of the heat dissipation wall,
the first and second top walls are connected to each of the two side walls,
the heat dissipation wall, the first and second top walls, and the two side walls jointly enclose the first and second guide channels,
the plurality of guide vanes are connected to the heat dissipation wall, and
each of the plurality of heat dissipation fins contacts the heat dissipation wall.

9. The housing structure according to claim 8, further comprising a filling material having a minimum thermal conductivity between the plurality of heat dissipation fins and the heat dissipation wall.

10. The housing structure according to claim 8, wherein the guide vanes are connected between the heat dissipation wall and one of the first and second top walls.

11. The housing structure according to claim 8, wherein the housing further comprises an optical port section, one end of each of the two side walls and one of the top walls are connected to the optical port section, and the optical port section includes an optical port.

12. The housing structure according to claim 8, wherein
the first and second top walls and the heat dissipation wall are staggered,
each of the plurality of guide vanes has a first end connected to an end of the first and second top walls, and an upper end connected to an inner surface of the heat dissipation wall and a lower end contacting the heat dissipation bottom plate of the heat dissipation component, and
the heat dissipation wall, the heat dissipation bottom plate, and the two side walls jointly enclose the heat dissipation channel.

13. The housing structure according to claim 12, wherein the heat dissipation bottom plate includes grooves, and each of the grooves is adapted to receive one of the heat dissipation fins or one of the plurality of guide vanes.

14. The housing structure according to claim 8, wherein the heat dissipation component further comprises two outer walls on opposite sides of the heat dissipation bottom plate, and the two outer walls respectively contact the two side walls.

15. The housing structure according to claim 14, wherein each of the two outer walls include a latch fixture.

16. The housing structure according to claim 14, wherein the heat dissipation bottom plate includes a plurality of first positioning parts, and the side and/or top walls of the housing include second positioning parts configured to mate with the first positioning parts.

17. The housing structure according to claim 8, wherein the housing includes a plurality of first assembly parts, the heat dissipation component includes a plurality of first fitting parts corresponding to the plurality of first assembly parts, and the heat dissipation component is detachably fixed to the housing with fasteners adapted to the plurality of first fitting parts and the plurality of first assembly parts.

18. The housing structure according to claim 17, wherein the housing and/or the heat dissipation component further comprises a second assembly part.

19. The housing structure according to claim 18, wherein each of the plurality of first assembly parts includes a threaded hole, each of the plurality of first fitting parts comprises a through hole, each of the fasteners comprises a bolt or screw configured to mate with the threaded hole, and the second assembly part comprises one or more threaded holes or through holes.

20. An optical module comprising a cover component, a circuit board, and the housing structure according to claim 1, wherein the cover component is detachable from the housing structure and surrounds an internal cavity, and the circuit board is in the internal cavity and between two outer walls extending from the heat dissipation bottom plate.
